(19) United States
(12) Patent Application Publication
(10) Pub. No.: US 2020/0026675 A1
(43) Pub. Date: Jan. 23, 2020

(54) Switching Method and Related Electronic System

(71) Applicant: Wistron Corporation, New Taipei City (TW)

(72) Inventor: Feng-Yuan Chen, New Taipei City (TW)

(21) Appl. No.: 16/198,657

(22) Filed: Nov. 21, 2018

(30) Foreign Application Priority Data
Jul. 20, 2018 (TW) 107125098

(51) Int. Cl. G06F 13/40; G06F 13/42

(52) U.S. Cl. CPC G06F 13/4022; G06F 2213/0042; G06F 13/4282

(57) ABSTRACT

A switching method is applied for a display device. The display device is coupled to a first computer device, an input device and a storage device, wherein the input device controls the first computer device through the display device, and the storage device exchanges data with the first computer device through the display device. The switching method comprises steps of when a user instructs to switch the first computer device through an input signal generated by the input device, switching the input device from controlling the first computer device to controlling a second computer device, and determining whether the storage device is exchanging data with the first computer device; and when the storage device is not exchanging data with the first computer device, switching the storage device from connecting with the first computer device to connecting with the second computer device.

### BACKGROUND OF THE INVENTION

### 1. Field of the Invention

The present invention relates to a switching method and related electronic system, and more particularly, to a switching method and related electronic system capable of enhancing operating efficiency.

### 2. Description of the Prior Art

To enhance hardware compatibility and system flexibility, most conventional computer systems use the universal serial bus (USB) transmission technique to connect with different input devices (such as keyboard, mouse, writing pad, etc.) and storage devices. The USB transmission technique may be utilized for connections between different devices and for data transmission, such that the computer system may integrate transmission interfaces to reduce extra hardware configurations.

In addition, when a user needs to manipulate and switch among multiple computer systems, a conventional manner is using a keyboard video mouse (KVM) switch coupled to the multiple computer devices, an input device, a storage device and a display device, so as to switch the input device, the storage device and the display device to a selected computer device at a time. In such a situation, the switching operation must be performed under a condition that the USB interfaces are all idle, i.e., the storage device does not exchange data. If the storage device is exchanging data while the user wants to switch the selected computer device, the user must stop exchanging data manually or via a standard process, which may reduce operating efficiency; moreover, if the connection between the storage device and the computer device is forcedly stopped, data integrity and lifetime of the storage device may be damaged.

Therefore, there is a need to improve over the prior art.

### SUMMARY OF THE INVENTION

It is therefore a primary objective of the present invention to provide a switching method and related electronic system capable of reducing system idle and enhancing operating efficiency, so as to improve the prior art.

In an aspect, the present invention provides a switching method, for a display device, wherein the display device is coupled to a first computer device, an input device and a storage device, the input device controls the first computer device via the display device, and the storage device exchanges data with the first computer device via the display device. The switching method comprises when a user instructs to switch the first computer device through an input signal generated by the input device, switching the input device from controlling the first computer device to controlling a second computer device, and determining whether the storage device is exchanging data with the first computer device; and when the storage device is not exchanging data with the first computer device, switching the storage device from connecting with the first computer device to connecting with the second computer device.

In another aspect, the present invention provides an electronic system, comprising at least a computer device, configured to perform computing operations; an input device, coupled to the at least a computer device, configured to receive operations of a user to generate an input signal for controlling the at least a computer device; a storage device, coupled to the at least a computer device, configured to exchange data with the at least a computer device; and a display device, coupled to the at least a computer device and the input device, the display device comprising a universal serial bus (USB) multiplexer, coupled to the at least a computer device, the input device and the storage device; and a processing unit, coupled to the input device and the universal serial bus multiplexer, configured to control operations of the USB multiplexer according to the input signal of the input device; wherein when the user instructs to switch a first computer device of the at least a computer device through the input signal generated by the input device, the processing unit controls the USB multiplexer to switch the input device from controlling the first computer device of the at least a computer device to controlling a second computer device of the at least a computer device, and determines whether the storage device is exchanging data with the first computer device; and when the storage device is not exchanging data with the first computer device, the processing unit controls the USB multiplexer to switch the storage device from connecting with the first computer device to connecting with the second computer device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an electronic system according to an embodiment of the present invention.

FIG. 2 illustrates a flowchart of a switching process according to an embodiment of the present invention.

FIG. 3 illustrates a schematic diagram of another electronic system according to an embodiment of the present invention.

### DETAILED DESCRIPTION

Certain terms are used in the following description and claims to refer to particular components. Those skilled in the art will appreciate, manufacturers may use different terms to refer to a component. This document does not intend to follow the difference component distinguished name as a way to differentiate components but functionally distinguished as a criterion. Mentioned in the following description and claims the terms “include” or “comprising” is an open-ended fashion, and thus should be interpreted to mean “including/include but not limited to.” Except, “coupled” are intended to mean either an indirect or direct electrical connection. Accordingly, described herein if a device is coupled to a second device, said first means represents may be directly electrically connected to said second means, or by connecting to other devices or indirectly electrically connected to said first means second means.

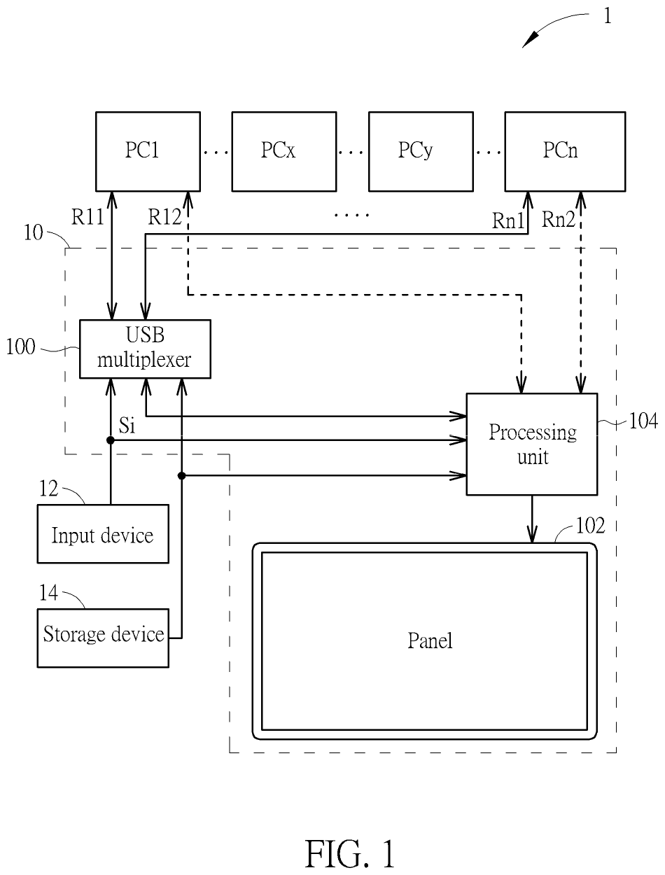

Please refer to FIG. 1, which is a schematic diagram of an electronic system 1 according to an embodiment of the present invention. As shown in FIG. 1, the electronic system 1 includes a display device 10, an input device 12, a storage device 14 and computer devices PC1-PCn. A user may use the display device 10 of the electronic system 1 to selectively control the computer devices PC1-PCn. The display device 10 connects to the input device 12, the storage device 14 and the computer devices PC1-PCn, and is utilized for displaying images of a computer device selected by the user. Moreover, the user may use the input device 12 to generate an input signal Si for controlling the selected computer device, and exchange data between the storage device 14 and the selected computer device. Note that, the input device 12 connects or communicates with the display device 10 and the computer devices PC1-PCn according to the transmission standard of USB 2.0, and the storage device 14 connects or communicates with the display device 10 and the computer devices PC1-PCn according to the transmission standard of USB 3.0.

Specifically, the computer device controlled by the user through the input device 12 is identical to the computer device exchanging data with the storage device 14. In such a situation, since operations of exchanging data should be consecutive and with no interrupt, to avoid reducing efficiency or damaging the storage device 14, the embodiment of the present invention respectively switches peripheral devices corresponding to the USB 2.0 transmission standard and the USB 3.0 transmission standard, such that the input device 12 and the storage device 14 are respectively switched. For example, when the user intends to switch the selected computer device from the computer device PC1 to the computer device PC2, but the storage device 14 is exchanging data with the computer device PC1, the electronic system 1 of the embodiment may first switch the input device 12 to connect with the computer device PC2, so as to control the computer device PC2 and decrease idle time; then, after the storage device 14 finishes exchanging data with the computer device PC1, the electronic system 1 switches the storage device 14 to connect with the computer device PC2, to finish the switching operation. In other words, the electronic system 1 may separately switch the peripheral devices corresponding to USB 2.0 and USB 3.0. When the user instructs to trigger the switching operation, the electronic system 1 immediately switches the input device 12 connecting with the USB 2.0 interface, and switches the storage device 14 connecting with the USB 3.0 interface after the data exchanging operation is finished, so as to reduce waiting time, prevent incomplete data transmission and protect the storage device 14, thereby enhancing operating efficiency of the electronic system 1 and prolonging lifetime of the storage device 14.

The display device 10 includes a USB multiplexer 100, a panel 102 and a processing unit 104. The USB multiplexer 100 is coupled to the input device 12, the storage device 14 and the computer devices PC1-PCn, for switching connections among the input device 12, the storage device 14 and the computer devices PC1-PCn. The panel 102 is coupled to the processing unit 104, for displaying images of the selected computer device. The processing unit 104 is coupled to the input device 12, the storage device 14 and the computer devices PC1-PCn, for receiving the input signal Si instructed by the user, and accordingly determining whether the input device 12 instructs to switch the selected computer device. When the input signal Si indicates to switch the selected computer device, the processing unit 104 first determines whether the storage device 14 is exchanging data, and accordingly indicates the switching method of the USB multiplexer 100, such that the input device 12 can timely switch the connection, and the data exchanging operation of the storage device 14 is not affected. Moreover, the processing unit 104 is further utilized for receiving images of the computer devices PC1-PCn and selectively transmitting to the panel 102 for follow-up displaying, such that the user may manipulate the selected computer device based on the images displayed by the panel 102.

Note that, the processing unit 104 may be a microprocessor (MCU), an application-specific integrated circuit (ASIC) or a video signal scaler, for processing image signals transmitted by the computer devices, and adjusting the image signals to display on the panel 102. Moreover, the USB multiplexer 100 may include multiple USB multiplexers corresponding to different standards/specifications, and the different USB multiplexers may be serially or parallel connected and integrated as the USB multiplexer 100, such that the display device 10 may follow the USB 2.0 standard to connect the input device 12, and follow the USB 3.0 standard to connect the storage device 14. In another aspect, according to various applications or design requirements, the input device 12 may be an independent device separated from the display device 10 and operated by the user, such as a keyboard, a mouse, a remote control device, a writing pad, a motion sensing camera, a motion sensing grip, etc. Alternatively, the input device 12 may be integrated in the display device 10, such as a touch panel, control pads disposed on the display device 10, etc. As long as the user may use the input device 12 to manipulate the selected computer device without extra hardware device and connect the input device 12 and the electronic system 1 via USB 2.0 to ensure that the electronic system 1 can receive the input signal Si generated by the input device 12, the input device 12 may be implemented by various devices or circuits. In addition, as shown in FIG. 1, the input signal Si generated by the input device 12 is transmitted to the USB multiplexer 100 and the processing unit 104. In different embodiments, the input signal Si generated by the input device 12 may be first transmitted to the USB multiplexer 100, and then to the processing unit 104, which is also within the scope of the present invention.

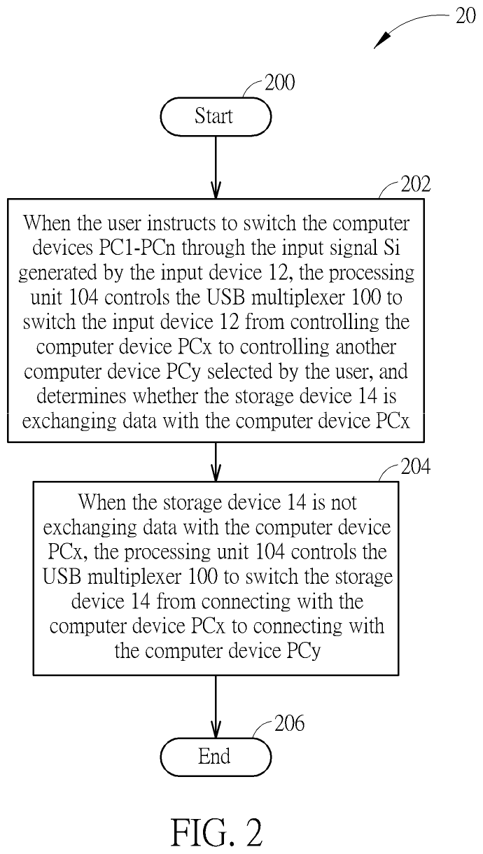

Please refer to FIG. 2, which is a schematic diagram of a switching process 20 according to an embodiment of the present invention. The switching process 20 is utilized in the electronic system 1 for switching the computer device selected by the user, such that the electronic system 1 may timely switch the input device 12 to connect to the selected computer device without affecting data exchanging operation of the storage device 14. In the embodiment, the user may operate the electronic system 1 according to the switching process 20, so as to switch the selected computer device from a computer device PCx to another computer device PCy within the computer devices PC1-PCn. The switching process 20 includes the following steps:

Step 200: Start.

Step 202: When the user instructs to switch the computer devices PC1-PCn through the input signal Si generated by the input device 12, the processing unit 104 controls the USB multiplexer 100 to switch the input device 12 from controlling the computer device PCx to controlling another computer device PCy selected by the user, and determines whether the storage device 14 is exchanging data with the computer device PCx.

Step 204: When the storage device 14 is not exchanging data with the computer device PCx, the processing unit 104 controls the USB multiplexer 100 to switch the storage device 14 from connecting with the computer device PCx to connecting with the computer device PCy.

Step 206: End.

In Step 202, the user uses the input device 12 to generate the input signal Si for controlling the computer device PCx, and exchanges data between the storage device 14 and the computer device PCx. When the user instructs to change the selected computer device to the computer device PCy though the input signal Si, the processing unit 104 accordingly instructs the USB multiplexer 100 to switch connection of the input device 12, i.e. from connecting with the computer device PCx to connecting with the computer device PCy. Next, the processing unit 104 determines whether the storage device 14 is exchanging data with the computer device PCx, to selectively switch connection between the storage device 14 and the computer device PCx. In detail, when the processing unit 104 determines that the storage device 14 is exchanging data with the computer device PCx, the processing unit 104 does not switch the connection between the storage device 14 and the computer device PCx. When the processing unit 104 determines that the storage device 14 is not exchanging data with the computer device PCx, the processing unit 104 executes Step 204, and the USB multiplexer 100 switches the storage device 14 from connecting with the computer device PCx to connecting with the computer device PCy according to indication of the processing unit 104. As a result, the display device 10 of the embodiment of the present invention switches the input device 12 and the storage device 14 to connect with the selected computer device, wherein the input device 12 is timely switched without intervention of the data exchanging operation of the storage device 14, while the data exchanging operation of the storage device 14 is kept unchanged. In short, the electronic system 1 of the embodiment uses the processing unit 104 to determine whether the storage device 14 is exchanging data, instructs the USB multiplexer 100 to switch connection, and allows the input signal Si generated by the input device 12 to timely switch to the selected computer device via the USB multiplexer 100, thereby reducing system idle, keeping data integrity and protecting the storage device 14, to enhance the operating efficiency and prolong the lifetime of the storage device 14.

Furthermore, in FIG. 1, the computer devices PC1-PCn and the USB multiplexer 100 are connected through routes R11-Rn1, and routes R12-Rn2 illustrated as dotted lines between the computer devices PC1-PCn and the processing unit 104 represent that under different USB standards, the computer devices PC1-PCn and the display device 10 may require the additional routes R12-Rn2 to accurately transmit the input signal Si and image signals of the computer devices PC1-PCn. In detail, when the routes R11-Rn1 between the computer devices PC1-PCn and the USB multiplexer 100 conform to the USB type-C specification, since the transmission bandwidth thereof is high enough to simultaneously transmit the input signal Si, image signals, etc., the computer devices PC1-PCn and the display device 10 may simultaneously achieve transmissions of the input signal Si, the image signals, etc. only though the routes R11-Rn1. On the other hand, when the routes R11-Rn1 between the computer devices PC1-PCn and the USB multiplexer 100 conform to the USB type-A specification, since the transmission bandwidth thereof is insufficient to simultaneously transmit the input signal Si and image signals, the computer devices PC1-PCn and the processing unit 104 may require the routes R12-Rn2 to transmit the image signals. In other words, when the routes R11-Rn1 are of USB type-A, the input signal Si of the user is transmitted to the computer devices PC1-PCn via the routes R11-Rn1, and the image signals of the computer devices PC1-PCn are transmitted to the processing unit 104 through the additional routes R12-Rn2 to be displayed by the panel 102. The techniques of in-/decreasing transmission routes according to specifications of connecting interfaces or transmission bandwidths should be well known in the art, which is not limited thereto.

In conclusion, the electronic system 1 of the embodiment may respectively switch the input device 12 applying the USB 2.0 specification and the storage device 14 applying the USB 3.0 specification, such that the input device 12 may timely switch to control the computer device selected by the user and may not be affected by data exchanging operations of the storage device 14. Therefore, the electronic system 1 of the embodiment can effectively reduce system idle, prevent breakage of the exchanged data and protect the storage device 14, so as to enhance operating efficiency and prolong lifetime of the storage device 14.

Note that, the above embodiments are utilized for illustrating the concept of the present invention, and those skilled in the art may accordingly make modifications. For example, in Step 20 of the process 20, the processing unit starts to determine whether the storage device is exchanging data after switching the input device. However, the processing sequence of the processing unit is not limited thereto. In Step 202, the processing unit 104 may first determine whether the storage device is exchanging data, and then instruct the USB multiplexer to simultaneously switch the input device and the storage device to connect with the selected computer device according to the determining result. Or, the processing unit 104 may instruct the USB multiplexer to switch the input device to connect with the selected computer device first, and switch the storage device to connect with the selected computer device after the storage device completes the data exchanging operations. As long as the processing unit switches the connection of the input device applying the USB 2.0 specification when the storage device is exchanging data, and then switches the connection of the storage device applying the USB 3.0 specification after the storage device finishes the data exchanging operations, related alternations are within the scope of the present invention.

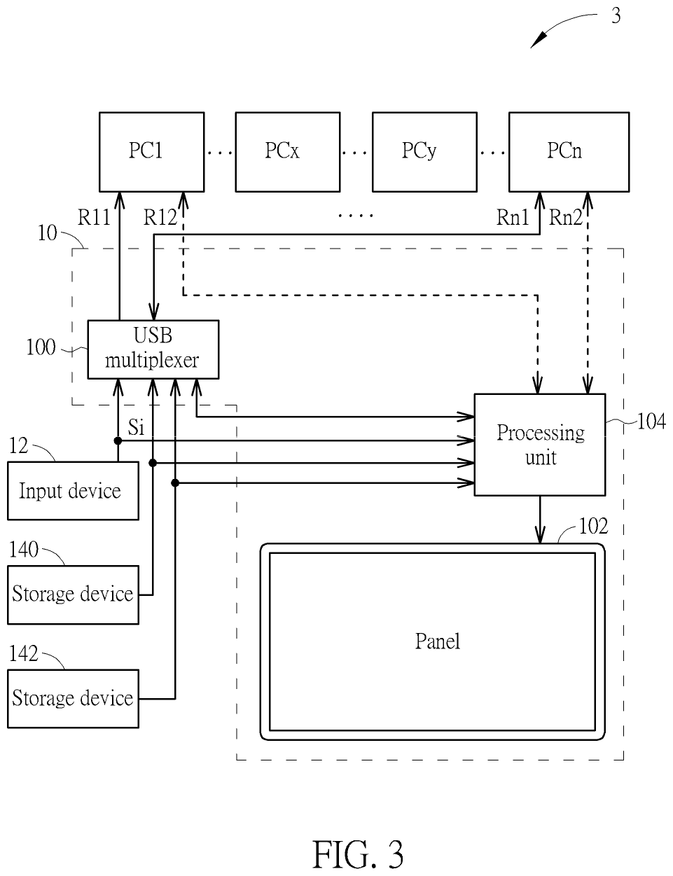

In addition, please refer to FIG. 3, which is a schematic diagram of an electronic system 3 according to an embodiment of the present invention. The electronic system 3 is similar to the electronic system 1, and the same components are denoted by the same notations. As shown in FIG. 3, different from the electronic system 1 which only includes the single storage device 14, the electronic system 3 includes storage devices 140 and 142 both connecting to the display device 10 through the USB 3.0 specification. In such a situation, when the user needs to switch the selected computer device from a computer device PCx to a computer device PCy, and the computer device PCx exchanges data with at least one of the storage devices 140 and 142, the electronic system 3 may first switch the input device 12 applying the USB 2.0 specification to connect with the computer device PCy. Then, after the storage devices 140 and 142 are not exchanging data, the electronic system 3 switches both the storage devices 140 and 142 applying the USB 3.0 specification to connect with the computer device PCy, so as to finish the switching operation.

In the prior art, when the user switches the USB 2.0 input device, the switching operation is affected by the USB 3.0 storage device. That is, if the USB 3.0 storage device is exchanging data, the user cannot switch the input device to control the selected computer device. Therefore, the conventional electronic system must wait for the USB 3.0 storage device to complete the data exchanging operation, or the user has to forcedly stop the data exchanging operation, and then the USB 2.0 input device can be switched. If the user waits for the completion of the data exchanging operation to switch the input device, the system idle occurs and the operating efficiency is reduced. If the user forcedly stops the data exchanging operation to switch the input device and the storage device, data integrity and hardware lifetime may be damaged. In comparison, the electronic system of the present invention connects the display device to the input device, the storage device and the computer device, timely switches the input device of USB 2.0 when the user indicates to switch the computer device, and then switches the storage device of USB 3.0 when the storage device finishes the data exchanging operation. Therefore, the electronic system of the present invention can timely switch the input device to reduce system idle, keep data integrity and prevent the storage device, so as to enhance the operating efficiency and prolong the lifetime of the storage device.

Those skilled in the art will readily observe that numerous modifications and alterations of the device and method may be made while retaining the teachings of the invention. Accordingly, the above disclosure should be construed as limited only by the metes and bounds of the appended claims.

1. A switching method, for a display device, wherein the display device is coupled to a first computer device, an input device and a storage device, the input device controls the first computer device via the display device, and the storage device exchanges data with the first computer device via the display device, the switching method comprising:
when a user instructs to switch the first computer device through an input signal generated by the input device, switching the input device from controlling the first computer device to controlling a second computer device, and determining whether the storage device is exchanging data with the first computer device; and
when the storage device is not exchanging data with the first computer device, switching the storage device from connecting with the first computer device to connecting with the second computer device.

2. The switching method of claim 1, wherein the input device connects with the first computer device or the second computer device according to a first transmission standard, and the storage device connects with the first computer device or the second computer device according to a second transmission standard.

3. The switching method of claim 2, wherein the first transmission standard is a transmission standard of universal serial bus 2.0, and the second transmission standard is a transmission standard of universal serial bus 3.0.

4. The switching method of claim 1, wherein the input device is at least one of a keyboard, a mouse, and a touch panel.

5. The switching method of claim 1, wherein the second computer device is at least one of a portable storage drive, a removable hard disk, a card reader, a portable electronic device.

6. An electronic system, comprising:
at least a computer device, configured to perform computing operations;
an input device, coupled to the at least a computer device, configured to receive operations of a user to generate an input signal for controlling the at least a computer device;
a storage device, coupled to the at least a computer device, configured to exchange data with the at least a computer device; and
a display device, coupled to the at least a computer device and the input device, the display device comprising:
a universal serial bus (USB) multiplexer, coupled to the at least a computer device, the input device and the storage device; and
a processing unit, coupled to the input device and the universal serial bus multiplexer, configured to control operations of the USB multiplexer according to the input signal of the input device;
wherein when the user instructs to switch a first computer device of the at least a computer device through the input signal generated by the input device, the processing unit controls the USB multiplexer to switch the input device from controlling the first computer device of the at least a computer device to controlling a second computer device of the at least a computer device, and determines whether the storage device is exchanging data with the first computer device; and when the storage device is not exchanging data with the first computer device, the processing unit controls the USB multiplexer to switch the storage device from connecting with the first computer device to connecting with the second computer device.

7. The electronic system of claim 6, wherein the input device connects with the at least a computer device according to a first transmission standard, and the storage device connects with the second computer device according to a second transmission standard.

8. The electronic system of claim 7, wherein the first transmission standard is a transmission standard of universal serial bus 2.0, and the second transmission standard is a transmission standard of universal serial bus 3.0.

9. The electronic system of claim 6, wherein the input device is at least one of a keyboard, a mouse, and a touch panel.

10. The electronic system of claim 6, wherein the second computer device is at least one of a portable storage drive, a removable hard disk, a card reader, a portable electronic device.
